(19) United States
(12) Patent Application Publication
(10) Pub. No.: US 2025/0063236 A1
(43) Pub. Date: Feb. 20, 2025

(54) MONITOR OF SUBCSRIPTION USAGE AND DETECTION OF ABUSE

(71) Applicant: Charter Communications Operating, LLG, St. Louis, MO (US)

(72) Inventors: Kei Yuk Foo, Englewood, CO (US); Jeffrey E. Calkins, Evergreen, CO (US); Vipul Patel, Parker, CO (US); Anthony R. Piro, Highlands Ranch, CO (US)

(21) Appl. No.: 18/234,514

(22) Filed: Aug. 16, 2023

(51) Int. Cl. H04N 21/8355; H04N 21/254

(52) U.S. Cl. CPC H04N 21/8355; H04N 21/2541

(57) ABSTRACT

A network environment includes a content delivery management resource that receives multiple requests from communication devices for retrieval and playback of video assets. The content delivery management resource identifies the multiple requests as being associated with a first subscriber account of multiple subscriber accounts. A usage monitor resource tracks attributes of processing the multiple requests associated with the first subscriber account to produce playback information (such as one or more digital rights management licenses) supporting playback of the video assets. The usage monitor resource then derives a usage metric for the first subscriber account based on the tracked attributes of processing the multiple requests.

### BACKGROUND

Conventional digital rights management (a.k.a., DRM) is generally the management of legal access to digital content. Various tools or technological protection measures such as access control technologies may restrict the playback of certain distributed video data. Thus, conventional implementation of DRM technology governs the use, modification, and distribution of digital assets.

As an example of implementation of digital rights management, a conventional communication device is able to request and retrieve content such as video for playback. The communication device can be configured to provide a token (generally, credentials associating the requesting communication device to an account) for authentication to a content management resource. Subsequent to authentication, the content management resource provides the requesting communication device a digital rights management license (a.k.a., a DRM license) to playback the requested content.

The DRM license may include information such as decryption keys to decrypt received segments of the requested content.

### BRIEF DESCRIPTION OF EMBODIMENTS

Techniques herein provide a way to monitor distribution of playback information such as DRM licenses to determine abuse associated with a subscriber account. An appropriate to misuse may be prevent subsequent distribution of requested DRM licenses associated with a subscriber account.

More specifically, a network environment as discussed herein includes a content delivery management resource that receives multiple requests from one or more communication devices (or at least one communication device) for retrieval and playback of video assets. The content delivery management resource identifies the multiple requests as being associated with a particular (first) subscriber account of multiple subscriber accounts. A usage monitor resource tracks attributes of processing the multiple requests to produce playback information (such as one or more digital rights management licenses) supporting playback of the requested video assets. The usage monitor resource then derives one or more usage metrics for the first subscriber account based on the tracked attributes of processing the multiple requests.

The generated usage metrics can be used for any suitable purpose. For example, each of the generated usage metrics can be configured to indicate a degree to which the first subscriber account is improperly used to retrieve video assets for playback. In one example, in response to detecting that a particular usage metric derived for the first subscriber account is above a threshold level, the content delivery management resource can be configured to prevent subsequent delivery of content (such as video assets) to communication devices identified as being associated with the first subscriber account.

In a further example, in response to the content delivery management resource receiving the multiple requests, the content delivery management resource: i) generates playback information (such as one or more DRM licenses), and ii) distributes the playback information to the communication devices, enabling the communication devices to playback the requested video assets. Prior to distributing the playback information to the communication devices, the content delivery management resource or other suitable entity can be configured to generate decryption information to decrypt the requested video assets and produce the playback information to specify the generated decryption information to decrypt the video assets as specified by the multiple requests. In accordance with one implementation, the content delivery management resource includes a wireless access point operative to wirelessly communicate the playback information over one or more respective wireless communication links to the communication devices.

In accordance with still further examples, a magnitude of a respective usage metric for the subscriber account indicates a degree of video asset demand associated with the subscriber account. The usage monitor resource can be configured to compare the magnitude of the usage metric to a threshold level and produce a notification indicating misuse of the playback information (such as digital rights management licenses) in response to detecting that the magnitude of the usage metric is greater than the threshold level.

Still further, the content delivery management resource and/or usage monitor resource as discussed herein can be configured to track attributes of processing the multiple requests associated with the subscriber account without regard to identities of the video assets being requested for playback.

Additionally, or alternatively, the content delivery management resource and/or usage monitor resource can be configured to: track the attributes of processing the multiple requests associated with the subscriber account without regard to identities of users of the communication devices generating the multiple requests.

In yet further examples, the attributes tracked by the content delivery management resource and/or the usage monitor resource include a first attribute and a second attribute. The first attribute is based on a number of the multiple requests received within a predetermined time duration; and the second attribute is based on unique network address identities of the communication devices generating the multiple requests. Derivation of the usage metric may include the usage monitor resource: i) producing a first numerical value from the first tracked attribute; and ii) producing a second numerical value from the second tracked attribute. Yet further, the usage monitor resource can be configured to apply a first weight value to the first numerical value to produce a first weighted value; apply a second weight value to the second numerical value to produce a second weighted value; and generate the usage metric for the subscriber account based on the first weighted value and the second weighted value. More specific examples of generating a respective usage metric associated with a respective subscriber account are further discussed herein.

In accordance with still further examples, the usage monitor as discussed herein derives one or more respective usage metric for the first subscriber account based on authentication tracking logs associated with authenticating the communication devices generating the multiple requests associated with the first subscriber account.

In accordance with yet further examples, the usage monitor as discussed herein derives the usage metric for the subscriber account based on management logs associated with producing the playback information in response to the multiple requests.

Embodiments herein are useful over conventional techniques. For example, implementation of the content delivery management resource to keep track of content requests, generation of digital rights management license, etc. As previously discussed, a corresponding usage monitor resource analyzing the attributes of the content delivery management resource processing the requests produces one or more metrics providing notifications of misuse or irregularities of a respective subscriber account to retrieve content.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium or computer readable storage hardware on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: receive multiple requests from at least one communication device specifying video assets for retrieval, the multiple requests identified as being associated with a first subscriber account of multiple subscriber accounts; track attributes of processing the multiple requests to produce playback information supporting playback of the video assets; and derive a usage metric for the first subscriber account based on the tracked attributes of processing the multiple requests.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed

Description section (which is a summary of embodiments) and corresponding figures of the present disclosure as further discussed below.

### BRIEF DESCRIPTION OF THE DRAWINGS

FIG. 1 is an example diagram illustrating a network environment in which multiple communication devices associated with a first subscriber account request retrieval of content for playback as discussed herein.

FIG. 2 is an example diagram illustrating implementation of a content delivery management resource operative to distribute playback information (such as device management resource licenses) to each of multiple communication devices requesting content based on a token (credentials) associated with a particular subscriber account as discussed herein.

FIG. 3 is an example diagram illustrating collection of log information associated with the communication devices requesting content as discussed herein.

FIG. 4 is an example diagram illustrating implementation of a usage management resource in the network environment to detect misuse/irregularities associated with a subscriber account and retrieval of content from multiple communication devices as discussed herein.

FIG. 5 is an example diagram illustrating implementation of a usage monitor function to generate a usage score associated with a subscriber account as discussed herein.

FIG. 6 is an example diagram illustrating implementation of a function to generate a usage score associated with a subscriber account as discussed herein.

FIGS. 7A, 7B, and 7C are example diagrams tracking generation of multiple instances of playback management information (such as digital rights management licenses) for a respective subscriber account as discussed herein.

FIG. 8 is an example diagram illustrating generation of an alert indicating detected misuse or irregularities associated with a subscriber account and corresponding retrieval of content as discussed herein.

FIG. 9 is an example diagram illustrating example computer hardware and software operable to execute operations according to embodiments herein.

FIG. 10 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

A network environment includes a content delivery management resource that receives multiple requests from communication devices for retrieval and playback of video assets. The content delivery management resource identifies the multiple requests as being associated with a first subscriber account of multiple subscriber accounts supporting distribution of content to subscribers. A usage monitor resource tracks attributes of processing the multiple requests associated with the first subscriber account to produce playback information (such as one or more digital rights management licenses) supporting playback of requested video assets. The usage monitor resource is further configured to derive a usage metric for the first subscriber account based on the tracked attributes of processing the multiple requests. The one or more usage metric as discussed herein can be used as a basis to prevent further distribution of content and/or playback information to communication devices associated with the first subscriber account depending on a magnitude of the usage metric.

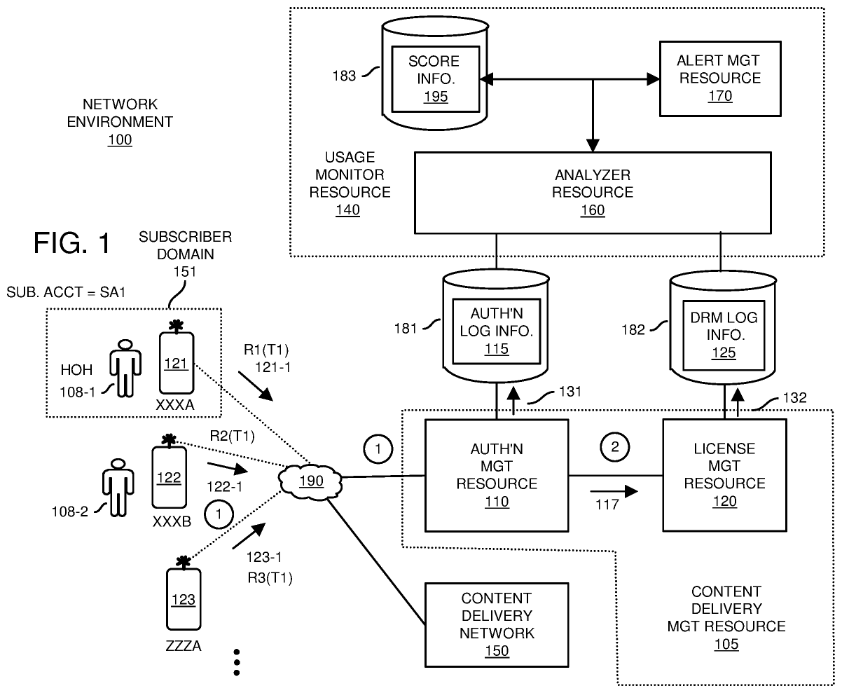

FIG. 1 is an example diagram illustrating a network environment in which multiple communication devices associated with a first subscriber account request retrieval of content for playback as discussed herein. The system in FIG. 1 and corresponding operations as discussed herein demonstrate how novel usage metrics efficiently identify bots and human abuse in DRM license requests.

As shown in this example, the network environment 100 includes communication devices (121, 122, 123, etc.), content delivery management resource 105, repository 181, repository 182, content delivery network 150, usage monitor resource 140, and so on. Repository 181 stores authentication log information 115 associated with authenticating communication devices for retrieval and playback of content. Repository 182 stores DRM log information 125 associated with generation of appropriate playback information enabling playback of the requested content.

A first communication link (such as a first wireless communication link) supports connectivity between the communication device 121 and the content delivery management resource 105; a second communication link (such as a second wireless communication link) supports connectivity between the communication device 122 and the content delivery management resource 105; a third communication link (such as a third wireless communication link) supports connectivity between the communication device 123 and the content delivery management resource 105; and so on.

The content delivery management resource 105 includes authentication management resource 110, license management resource 120, etc.

The usage monitor resource 140 includes analyzer resource 160, alert management resource 170, repository 183, etc.

Note that any of the resources or entities as described herein can be configured as hardware, software, or a combination of both hardware and software. For example, the content delivery management resource 105 can be configured as content delivery management hardware, content delivery management software, or a combination of content delivery management hardware and content delivery management software; the authentication management resource 110 can be configured as authentication management hardware, authentication management software, or a combination of authentication management hardware and authentication management software; license management resource 120 can be configured as license management hardware, license management software, or a combination of license management hardware and license management software; content delivery network 150 can be configured as content delivery hardware, content delivery software, or a combination of content delivery hardware and content delivery software; the usage monitor resource 140 can be configured as usage monitor hardware, usage monitor software, or a combination of usage monitor hardware and usage monitor software; analyzer resource 160 can be configured as analyzer hardware, analyzer software, or a combination of analyzer hardware and analyzer software; alert manager resource 170 can be configured as alert management hardware, alert management software, or a combination of alert management hardware and alert management software; and so on.

The multiple communication devices 121, 122, 123, etc., are in communication with content delivery management resource 105 over network 190 (such as a wireless network). One or more of the communication devices are legitimately associated with the subscriber domain 151. For example, the communication device 121 is operated by the user 108-1 such as subscriber or head-of-household user paying fees for the subscriber account SA1 and corresponding retrieval of content (such as video assets) from the content delivery network 150. Communication device 122 may reside in or outside the subscriber domain 151 as well and be legitimately provided content delivery services because the user 108-2 is affiliated with the user 108-1.

One or more communication devices such as communication device 123 may be illegitimate users or computers that retrieve and playback content using services associated with the subscriber account SA1 assigned to the subscriber domain 151 and corresponding legitimate users associated with the subscriber domain 151. The operator and/or communication device 123 may improperly obtain credentials associated with the subscriber account SA1 to retrieve playback information from content delivery management resource 105 and content from the content delivery network 150 for playback.

In general, in operation #1, the content delivery management resource 105 receives requests for content from the multiple communication devices. After successful authentication by the authentication management resource 110 of each communication device, the corresponding authentication management resource 110 requests generation of a corresponding DRM license (associated with the requested content and authenticated user) from the license management resource 120 for delivery to a respective communication device and corresponding user requesting the content.

Note that the DRM license (playback information) is issued by the license management resource 120 to the client (such as content requesting communication device) with information for the corresponding device to decrypt the requested video content so that it can be display a rendition of the video on a respective display screen of the communication device. The client (communication device) then makes stream requests (such as requesting segments of content from as specified by a manifest file) to a content delivery network 150, which returns encrypted video segments to the requesting communication device. Using playback information (such as DRM license information) communicated to the respective communication device, the communication device decrypts the segment of retrieved content for playback. The usage monitor resource 140 monitors attributes associated with the requests associated with a respective subscriber account (from communication devices 121, 122, 123, etc.) and provides alerts in cases where the number of requests (such as for a given time duration) associated with the subscriber account SA1 is above a threshold level.

More specifically, via wired or wireless communications 121-1 transmitted from the mobile communication device 121 over network 190 to the authentication management resource 110, the authentication management resource 110 receives one or more requests for specific titles of video content from the mobile communication device 121 and corresponding user 108-1; via wired or wireless communications 122-1 transmitted from the mobile communication device 121 over network 190 to the authentication management resource 110, the authentication management resource 110 receives one or more requests for specific titles of video content from the mobile communication device 122 and corresponding user 108-2; via wired or wireless communications 123-1 transmitted from the communication device 123 over network 190 to the authentication management resource 110, the authentication management resource 110 receives one or more requests for specific titles of video content from the unmanned communication device 123; and so on.

Note that each of the communications 121-1, 122-1, 123-1, etc., (such as including corresponding requests R1, R2, R3, etc., for content), can be configured to include a respective token Tl (i.e., credentials) associated with the subscriber domain 151.

In one implementation, a respective communication device provides appropriate for authentication. The requesting communication device receives a token (such as token T1) associated with the subscriber account SA1. The respective communication device uses the token T1 to obtain a respective license to playback requested content.

The subscriber domain 151 and corresponding communication devices associated with the subscriber account SA1 are serviced by a content delivery service provider operating the content delivery management resource 105 and/or content delivery network 150. The token T1 (such as credentials associated with the subscriber account SA1 and associated with the subscriber domain 151) can be configured to include any suitable information such as information for authenticating that a respective communication device generating the request is authorized to request and retrieve content associated with the corresponding subscriber account.

In this example, communication device 121 generates requests R1 (each request including access token T1) assigned to the subscriber account SA1 allocated to the user 108-1; communication device 122 generates requests R2 (each request including access token T1) assigned to the subscriber account SA1 allocated to the user 108-1; communication device 123 generates requests R3 (each request including access token T1) assigned to the subscriber account SA1 allocated to the user 108-1; and so on.

As previously discussed, the token T1 or other suitable information in each of the request communications provides an indication to the content delivery management resource 105 that the corresponding communication device is associated with the subscriber account SA1. As previously discussed, certain communication devices using the token T1 (access credentials) associated with the subscriber account SA1 may freeload, improperly using the credentials (a.k.a., token T1) associated with the subscriber account SA1 to retrieve content. The improper use of the credentials (associated with the subscriber account SA1) makes it appear as though such users and communication devices are legitimately associated with the subscriber account SA1 even though they are not.

As previously discussed, the access token T1 (i.e., access credentials) associated with the subscriber account SA1 can include any suitable information. For example, the access token T1 assigned to or associated with the subscriber count SA1 can be configured to include security credentials for a login session and identify the user, the user's groups, the user's privileges, and, in some cases, a particular application.

In response to receiving a respective request for content after authentication of the requesting device via a respective access token T1 associated with the subscriber account SA1 or other suitable information provided by the requesting communication device t user equipment the subscriber account SA1, the content delivery management resource 105 produces and then provides playback information such as digital rights management licenses forwarded to the requesting communication device to playback corresponding requested content.

Each digital rights management license information (a.k.a., playback information) can be configured to include a manifest file indicating the different segments of content available retrieval as well as corresponding information indicating where to retrieve an appropriate decryption key to decrypt each retrieved segment of content associated with the requested content.

As further shown, the content delivery management resource 105 includes authentication management resource 110 and license management resource 120. As previously discussed, the network environment 100 also includes repository 181 and repository 182. The repository 181 stores authentication log information 115 associated with the authentication of the communication devices via the authentication management resource 110. The repository 182 stores information associated with generation of playback information (such as digital rights management license information) provided to the communication devices to playback corresponding requested content.

Further in this example, note that the communication device 121 is operated by the user 108-1, the communication device 122 is operated by the user 108-2, the communication device 123 is not operated by any user and may be a robot or other entity, and so on. As previously discussed, the communication device 123 has illegitimately acquired the token T1 (credentials) associated with subscriber account SA1 and uses such credentials to improperly retrieve and playback content.

Note that each of the communication devices 121, 122, etc., can be any suitable type of device such as a cellular phone device, bot, robot, computer, user equipment, mobile device, personal digital assistant, touch pad device, portable computer, wire-line telephone, wireless phone, wireless mobile device, etc.

Further in this example, note that the communication device 121 is assigned unique network address (unique identifier value) such as XXXA; the communication device 122 is assigned unique network address (unique identifier value) such as XXXB; the communication device 123 is assigned unique network address (unique identifier value) such as ZZZA; and so on.

When generating a respective instance of request R1 for content, the communication device 121 communicates any suitable information such as its network address XXXA, a title of requested video content, as well as appropriate authentication information (credentials such as token T1) indicating that the corresponding communication device 121 is associated with the subscriber account SA1. More specifically, at time T11, via communications 121-1, assume that the communication device 121 communicates its network address XXXA, a request R1-1 for retrieval and playback of content A1, as well as token Tl (or other authentication/credential information associated with the subscriber account SA1) to the authentication management resource 110 for retrieval of content A1 and corresponding DRM license information to playback the content A1; at time T12, via communications 121-1, assume that the communication device 121 communicates its network address XXXA, a request R1-2 for retrieval and playback of content A2, as well as token T1 (or other authentication/credential information associated with the subscriber account SA1) to the authentication management resource 110 for retrieval of content A2 and corresponding DRM license information to playback the content A2; at time T13, via communications 121-1, assume that the communication device 121 communicates its network address XXXA, a request R1-3 for retrieval and playback of content A3, as well as token T1 (or other authentication/credential information associated with the subscriber account SA1) to the authentication management resource 110 for retrieval of content A3 and corresponding DRM license information to playback the content A3; and so on.

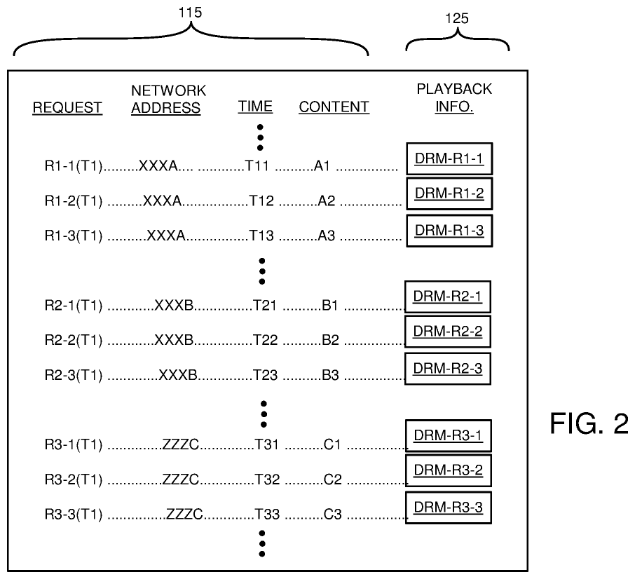

For each request R1 for content from the communication device 121, the authentication management resource 110 authenticates the respective communication device 121 and keeps track of respective authentication log information indicating a time of receiving the respective request, a network address of the requesting communication device, and a title of the requested content. See FIG. 2 indicating the tracked request information.

When generating a respective instance of request R2 for content, the communication device 122 communicates information such as its network address XXXB, a title of requested video content, as well as appropriate authentication information (such as token T1) indicating that the corresponding communication device 122 is associated with the subscriber account SA1. More specifically, at time T21, via communications 122-1, assume that the communication device 122 communicates its network address XXXB, a request R2-1 for retrieval and playback of content B1, as well as token T1 (or other authentication/credential information associated with the subscriber account SA1) to the authentication management resource 110 for retrieval of content B1 and corresponding DRM license information to playback the content B1; at time T22, via communications 122-1, assume that the communication device 122 communicates its network address XXXB, a request R2-2 for retrieval and playback of content B2, as well as token T1 (or other authentication/credential information associated with the subscriber account SA1) to the authentication management resource 110 for retrieval of content B2 and corresponding DRM license information to playback the content B2; at time T13, via communications 122-1, assume that the communication device 122 communicates its network address XXXB, a request R2-3 for retrieval and playback of content B3, as well as token T1 (or other authentication/credential information associated with the subscriber account SA1) to the authentication management resource 110 for retrieval of content B3 and corresponding DRM license information to playback the content A3; and so on.

For each request R2 for content from the communication device 122, the authentication management resource 110 keeps track of respective authentication log information indicating a time of receiving the request, a network address of the requesting communication device, and a title of the requested content. See FIG. 2 indicating the tracked request information.

When generating a respective instance of request R3 for content, the communication device 123 communicates its network address ZZZA, a title of requested video content, as well as appropriate authentication information (such as token T1 or other authentication/credential information associated with the subscriber account SA1) indicating that the corresponding communication device 123 is associated with the subscriber account SA1. More specifically, at time T31, via communications 123-1, assume that the communication device 123 communicates its network address ZZZA, a request R3-1 for retrieval and playback of content C1, as well as token T1 (or other authentication/credential information associated with the subscriber account SA1) to the authentication management resource 110 for retrieval of content C1 and corresponding DRM license information to playback the content C1; at time T32, via communications 123-1, assume that the communication device 123 communicates its network address ZZZA, a request R3-2 for retrieval and playback of content C2, as well as token T1 (or other authentication/credential information associated with the subscriber account SA1) to the authentication management resource 110 for retrieval of content C2 and corresponding DRM license information to playback the content C2; at time T33, via communications 123-1, assume that the communication device 123 communicates its network address ZZZA, a request R3-3 for retrieval and playback of content C3, as well as token T1 (or other authentication/credential information associated with the subscriber account SA1) to the authentication management resource 110 for retrieval of content C3 and corresponding DRM license information to playback the content C3; and so on.

For each request R3 for content from the communication device 123, the authentication management resource 110 keeps track of respective authentication log information indicating a time of receiving the request, a network address of the requesting communication device, and a title of the requested content. See FIG. 2 indicating the tracked request information.

Referring again to FIG. 1, via operation #2, for each of the respective requests (R1, R2, R3, etc.), via communications 117, the authentication management resource 110 forwards notification of the requests to the license management resource 120 for generation of respective playback information (such as digital rights management license) for use by the requesting communication device to playback the requested content.

FIG. 2 is an example diagram illustrating collection of log information associated with the communication devices requesting content as discussed herein.

As previously discussed, via communications 121-1, the authentication management resource receives request R1-1 for content A1. The authentication management resource 110 stores the information associated with the request R1-1 in the repository 181 as authentication log information 115. The license management resource 120 produces playback information DRM-R1-1 including appropriate playback information for the requested communication device 121 to playback the requested content A1.

Via communications 121-1, the authentication management resource receives request R1-2 for content A2. The authentication management resource 110 stores the information associated with the request R1-2 in the repository 181 as authentication log information 115. The license management resource 120 produces playback information DRM-R1-2 including appropriate playback information for the requested communication device 121 to playback the requested content A2.

Via communications 121-1. the authentication management resource receives request R1-3 for content A3. The authentication management resource 110 stores the information associated with the request R1-3 in the repository 181 as authentication log information 115. The license management resource 120 produces playback information DRM-R1-3 including appropriate playback information for the requested communication device 121 to playback the requested content A3.

Via communications 122-1, the authentication management resource receives request R2-1 for content B1. The authentication management resource 110 stores the information associated with the request R2-1 in the repository 181 as authentication log information 115. The license management resource 120 produces playback information DRM-R2-1 including appropriate playback information for the requested communication device 122 to playback the requested content B1.

Via communications 122-1, the authentication management resource receives request R2-2 for content B2. The authentication management resource 110 stores the information associated with the request R2-2 in the repository 181 as authentication log information 115. The license management resource 120 produces playback information DRM-R2-2 including appropriate playback information for the requested communication device 122 to playback the requested content B2.

Via communications 122-1, the authentication management resource receives request R2-3 for content B3. The authentication management resource 110 stores the information associated with the request R3-3 in the repository 181 as authentication log information 115. The license management resource 120 produces playback information DRM-R2-3 including appropriate playback information for the requested communication device 121 to playback the requested content B3.

Via communications 123-1, the authentication management resource receives request R3-1 for content C1. The authentication management resource 110 stores the information associated with the request R3-1 in the repository 181 as authentication log information 115. The license management resource 120 produces playback information DRM-R3-1 including appropriate playback information for the requested communication device 123 to playback the requested content C1.

Via communications 123-1, the authentication management resource receives request R3-2 for content C2. The authentication management resource 110 stores the information associated with the request R3-2 in the repository 181 as authentication log information 115. The license management resource 120 produces playback information DRM-R3-2 including appropriate playback information for the requested communication device 123 to playback the requested content C2.

Via communications 123-1, the authentication management resource receives request R3-3 for content C3. The authentication management resource 110 stores the information associated with the request R3-3 in the repository 181 as authentication log information 115. The license management resource 120 produces playback information DRM-R3-3 including appropriate playback information for the requested communication device 121 to playback the requested content C3.

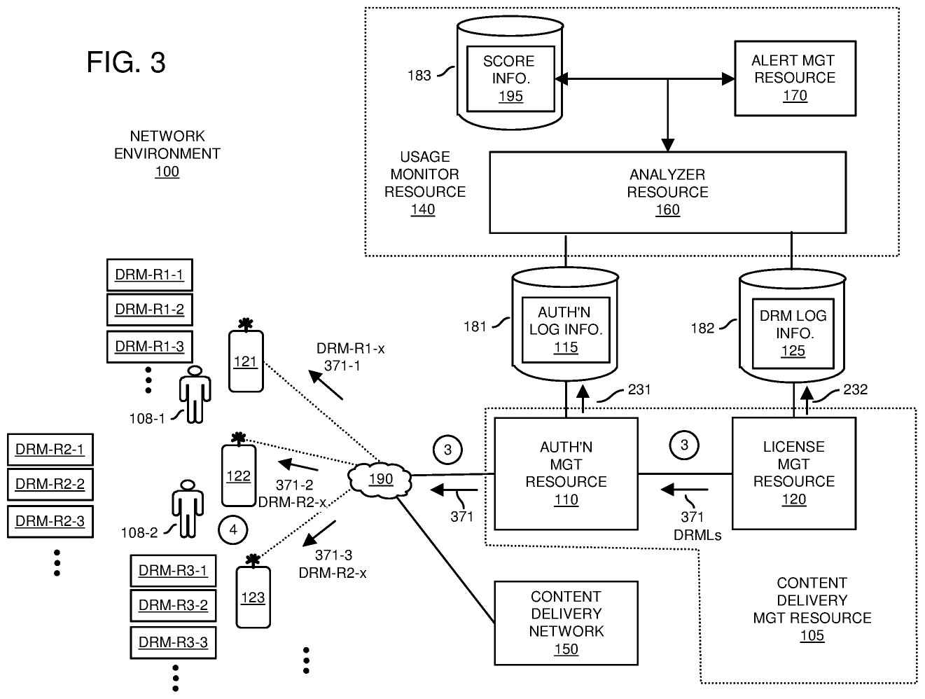

FIG. 3 is an example diagram illustrating implementation of a content delivery management resource in the network environment to distribute playback information (such as device management resource licenses) to each of the communication devices as discussed herein.

As previously discussed, in operation #2, after a respective user and/or communication device is authenticated and authorized to playback requested video content on a device, the authentication management resource 110 passes a content license request (such as DRM license request associated with the requested content) to the license management resource 120 (such as a digital rights management platform).

Because content protection mechanism DRM is implemented to keep video content secure through encryption, generated playback information such as a DRM license containing decryption information must be provided to the client device for successful video playback.

In this example, in operation #3, the content delivery management resource 105 and/or the license management resource 120 (such as DRM platform) creates the playback information (DRM license) for each request and sends it through authentication management resource 110 or other suitable entity over the network 190 to the client (communication device requesting content).

More specifically, via communications 371, the license management resource 120 communicates respective playback information over network 190 to each of the different requesting communication devices.

In such an instance, via communications 371-1, in response to each request, the content delivery management resource 105 and/or license management resource 120 delivers playback information DRM-R1-1 (supporting playback of requested content A1), playback information DRM-R1-2 (supporting playback of requested content A2), playback information DRM-R1-3 (supporting playback of requested content A3), etc., over network 190 to the communication device 121.

Via communications 371-2, in response to each request, the content delivery management resource 105 and/or license management resource 120 delivers playback information DRM-R2-1 (supporting playback of requested content B1), playback information DRM-R2-2 (supporting playback of requested content B2), playback information DRM-R2-3 (supporting playback of requested content B3), etc., over network 190 to the communication device 122.

Via communications 371-3. in response to each request, the content delivery management resource 105 and/or license management resource 120 delivers playback information DRM-R3-1 (supporting playback of requested content C1), playback information DRM-R3-2 (supporting playback of requested content C2), playback information DRM-R3-3 (supporting playback of requested content C3), etc., over network 190 to the communication device 123.

Thus, in response to the content delivery management resource 105 receiving the multiple requests as discussed herein, the content delivery management resource 105: i) generates the corresponding playback information such as playback information DRM-R1-1, playback information DRM-R1-2, playback information DRM-R1-3, . . . playback information DRM-R2-1, playback information DRM-R2-2, playback information DRM-R2-3, and so on. As previously discussed, the content delivery management resource 105 in operation #3 distributes this playback information to the communication devices.

In one example implementation, prior to distributing the playback information to each of the communication devices, the content delivery management resource 105: generates decryption information such as appropriate keys to decrypt the requested video assets; and produces the playback information to specify locations of the generated decryption information (such as keys) that is to be used to decrypt the video assets specified by the multiple requests.

As further discussed below, each of the communication devices uses the received playback information to playback corresponding requested content.

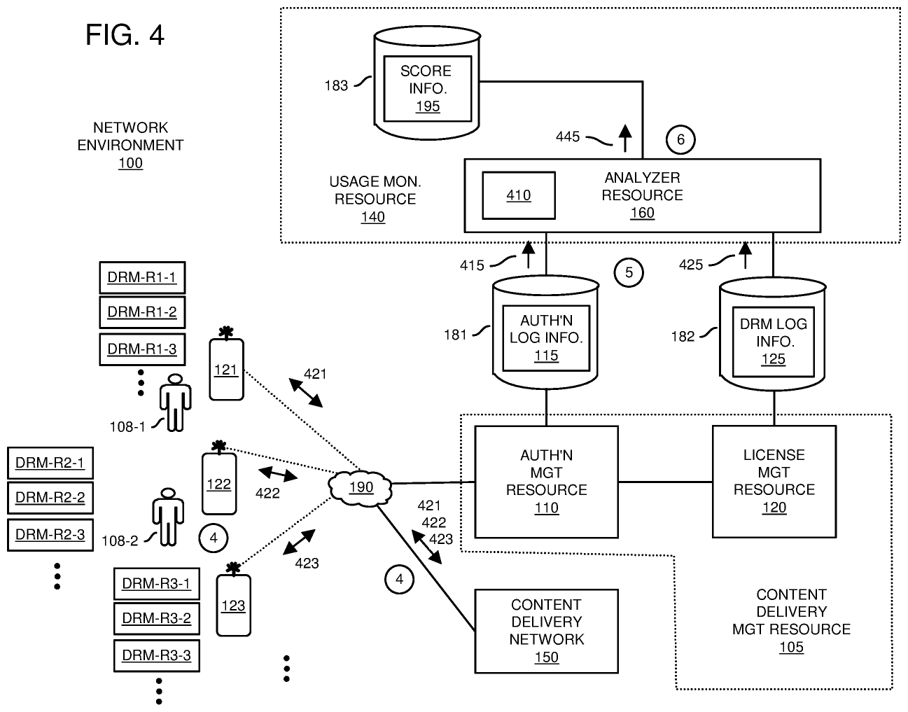

FIG. 4 is an example diagram illustrating implementation of a usage management resource in the network environment to detect subscriber account misuse/irregularities as discussed herein.

As further shown in operation #4, each of the client communication devices (i.e., requesting communication device receiving the playback information for the requested content) then makes a stream request to the content delivery network 150 for video segment which the client will use the information provided in the DRM license to decrypt the video and displayed on the device. To properly secure IP video content, each set of requested content is individually encrypted. This means as user channel change from one to another (i.e., viewing different requested content), a new DRM license (playback information) is needed. In addition, note that DRM licenses (instances of playback information as discussed herein) also have expiration time that request for new license would also be needed to continue video playback. And the current workflow requires client communication devices to make a valid token request before a DRM license request can be made because the token duration for requesting content is short. Because of this workflow, the number of token requests to the authentication management resource 110 should be a close equivalent to the number of DRM license request (or content requests).

In one example, each of the instances of playback information is valid for use up to an assigned time duration such as 24 hours or other suitable amount. Each set of playback information can be configured to include information such as a manifest file indicating where to retrieve different segments of the requested content, pointers to decryption keys to be retrieved by the communication device to decrypt the retrieved segments of content, and so on.

Using the playback information DRM-R1-1, and via communications 421, the communication device 121 wirelessly communicates with the content delivery network 150 to retrieve segments of content associated with the requested content A1; using the playback information DRM-R1-2, and via communications 421, the communication device 121 wirelessly communicates with the content delivery network 150 to retrieve segments of content associated with the requested content A2; using the playback information DRM-R1-3, and via communications 421, the communication device 121 wirelessly communicates with the content delivery network 150 to retrieve segments of content associated with the requested content A3; and so on.

Using the playback information DRM-R2-1, and via communications 422, the communication device 122 wirelessly communicates with the content delivery network 150 to retrieve segments of content associated with the requested content B1; using the playback information DRM-R2-2, and via communications 422, the communication device 122 wirelessly communicates with the content delivery network 150 to retrieve segments of content associated with the requested content B2; using the playback information DRM-R2-3, and via communications 422, the communication device 122 wirelessly communicates with the content delivery network 150 to retrieve segments of content associated with the requested content B3; and so on.

Using the playback information DRM-R3-1, and via communications 423, the communication device 123 wirelessly communicates with the content delivery network 150 to retrieve segments of content associated with the requested content C1; using the playback information DRM-R3-2, and via communications 423, the communication device 123 wirelessly communicates with the content delivery network 150 to retrieve segments of content associated with the requested content C2; using the playback information DRM-R3-3, and via communications 423, the communication device 123 wirelessly communicates with the content delivery network 150 to retrieve segments of content associated with the requested content C3; and so on.

Note further that an average user (and corresponding subscriber account associated with a respective user) should experience normal use and have a reasonable number of associated DRM license requests per day, normal rate of request per second, and reasonable number of originating IP addresses (associated with the communication devices) generating those requests for content. Authentication information (access token T1 such as including credentials to access use of services) associated with the subscriber account SA1 may be misused, potentially known or unbeknownst to the user 108-1. For example, so-called bots (robots) and abusive human behavior associated with request and retrieval of content would lead to, for a given subscriber account SA1, a higher number of DRM licenses requests per day, higher rate of requests per second, a wider range, and a larger number of unique originating IP addresses (of those requesting communication devices) which may indicate outside the normal household usage.

Thus, during normal use, multiple communication devices associated with subscriber domain 151 may legitimately use content delivery services associated with the subscriber account SA1 assigned to the user 108-1 (such as head-of-household subscriber associated with subscriber domain 151).

As further shown, the data (such as authentication log information 115, DRM log information 125, etc.) stored in the repositories as gathered is used by the analyzer resource 160 to compute a set of novel metrics indicating subscriber account use, without the analyzer resource 160 or other suitable entity from having to dig into the details of users' privacy related to what content they consume and from where they consume the content. In other words, the content delivery management resource 105 can be configured to track attributes of processing the multiple requests associated with the subscriber account SA1 without regard to identities of the video assets (a.k.a., content) being requested for playback by the communication devices or identities of the users operating the communication devices.

In accordance with further examples as discussed herein, the content delivery management resource 105 can be configured to track the attributes of processing the multiple requests associated with the subscriber account SA1 and corresponding communication devices without regard to identities of users (108-1, 108-2, etc.) of the one or more communication devices generating the multiple requests.

Listed in the table below are the descriptions of the novel metrics repeatedly 10 generated by the analyzer resource 160 based on the data stored in repository 181 and repository 182 for a time duration.

TABLE 1

| Metric | Description | Data Range and Score |
|---|---|---|
| SRGCT | represents the number of | Count, Attribute, Score |
| | surrogate (SRG) token | 0, None, 0 |
| | requests (or generally | 1 to 10, Low, 1 |
| | content requests R from | 11 to 20, Moderate, 2 |
| | communication devices | 21 to 100, High, 3 |
| | with appropriate provided | 101 to 200, Very High, 4 |
| | credentials) that took place | 201+, Extreme, 5 |
| | for a given time duration | |
| | such as a day. The token | |
| | request is roughly | |
| | equivalent to DRM license | |
| | request for video content. | |
| IPCT | IP count (IPCT) represents | Count, Attribute, Score |
| | how many different unique | 1, None, 0 |
| | IP addresses attributed to | 2 to 3, Low, 1 |
| | the SRG count in the | 4 to 5, Moderate, 2 |
| | day. Expectation is that | 6 to 10, High, 3 |
| | SRG token requested | 11 to 20, Very High, 4 |
| | should be originated from 1 | 21+, Extreme, 5 |
| | to 2 unique customer IP | |
| | addresses. | |
| CONCUR_{—} | represents the number of | Count, Attribute, Score |
| CT | SRGs (unique content), via | 1, None, 0 |
| | multiple unique IPs, were | 2 to 3, Low, 1 |
| | used to view content | 4 to 5, Moderate, 2 |
| | concurrently observed in | 6 to 10, High, 3 |
| | the day. This is a heuristic | 11 to 20, Very High, 4 |
| | viewing count assuming | 21+, Extreme, 5 |
| | two SRG requests from two | |
| | different IPs, taking place | |
| | within a window (currently | |
| | set to 60 seconds) are | |
| | concurrent views. We don't | |
| | have viewing duration data | |
| | and use the heuristic to | |
| | estimate concurrent | |
| | viewing. | |
| CONCUR_{—} | represents accounts for the | Count, Attribute, Score |
| IPCT | number of unique IPs that | 0, None, 0 |
| | viewed content | 1, Low, 1 |
| | concurrently in the day, per | 2 to 3, Moderate, 2 |
| | the heuristic | 4 to 5, High, 3 |
| | | 6 to 8, Very High, 4 |
| | | 9+, Extreme, 5 |
| BURST_{—} | represents all account | Count, Attribute, Score |
| RATE_{—} | transactions by unique IP | 0 to 0.99, None, 0 |
| PER_MIN | are used to calculate an | 1.0 to 1.99, Low, 1 |
| | SRG request rate in events | 2.0 to 2.99, Moderate, 2 |
| | per minute observed in a | 3.0 to 9.99, High, 3 |
| | day. These rates are | 10 to 19.99, Very High, 4 |
| | instantaneous calculations | 20.0+, Extreme, 5 |
| | and back-to-back (100 msec | |
| | apart) transactions yield | |
| | spikes in the data, but the | |
| | spikes are useful in | |
| | identifying automation | |
| | processes | |
| MEAN_{—} | represents overall SRG (or | Count, Attribute, Score |
| RATE_{—} | content request) | 0 to 0.99, None, 0 |
| PER_MIN | transactions in a day, this is | 1.0 to 1.99, Low, 1 |
| | the mean or average SRG | 2.0 to 2.99, Moderate, 2 |
| | “rate per minute” | 3.0 to 9.99, High, 3 |
| | | 10 to 19.99, Very High, 4 |
| | | 20.0+, Extreme, 5 |

In one embodiment, for each day or other time duration, the analyzer resource 160 produces a respective value for each variable or metric in table 1 such as usage metrics SRGCT, IPCT, CONCUR_CT, CONCUR_IPCT, BURST_RATE_PER_MIN, MEAN_RATE_PER_MIN based on the data (115 and store repository 181 and 182. The value generated for each variable itself can be compared to a threshold level to determine improper usage of credentials associated with the subscriber account SA1 to generate a respective alert. Alternatively, the alert management resource 170 can be configured to generate a respective composite score CSCORE as discussed herein based on the above scores generated for each variable.

In operation #5, the analyzer resource 160 (usage monitor resource 140) retrieves and analyzes the information stored in repository 181 and repository 182. In operation #6, the analyzer resource 160 generates metrics stored in repository 183.

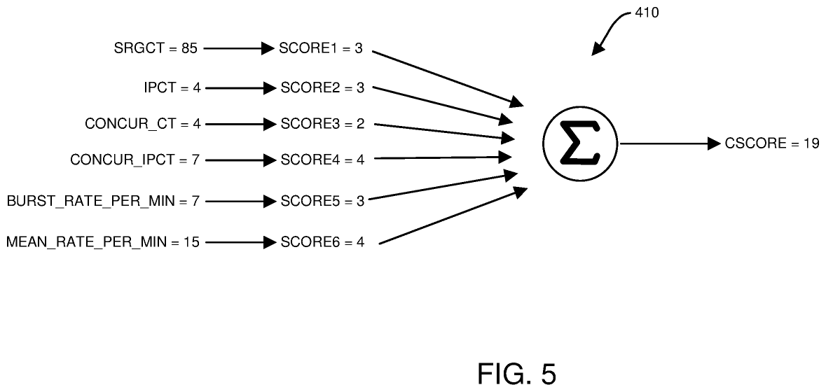

For example, as shown in FIG. 5 via implementation of function 410, assume that the usage monitor resource 140 such as via corresponding analyzer resource 160 detects that, for a given day associated with subscriber account SA1:
SRGCT=85 falls in range 21 to 100 so score1=3;
IPCT=4 (four communication devices with different INDUCTIVE PATH address) falls in range 4 to 5 so score2=3;
CONCUR_CT=4 falls in range 4 to 5 so score3=2;
CONCUR_IPCT=7 falls in range 6 to 8 so score4=4;
BURST_RATE_PER_MIN=7 falls in range 3 to 10 so score5=3;
MEAN_RATE_PER_MIN=15 falls in range 10 to 20 so score6=4.

Via the function 410, the usage monitor resource 140 generates a respective value for CSCORE based on one or more of the metrics:

$$CSCORE = SRGCT + IPCT + CONCUR\_CT + CONCUR\_IPCE + BURST\_RATE \_PER \_MIN + MEAN\_RATE \_PER \_MIN = 3 + 3 + 2 + 4 + 3 + 4 = 19$$

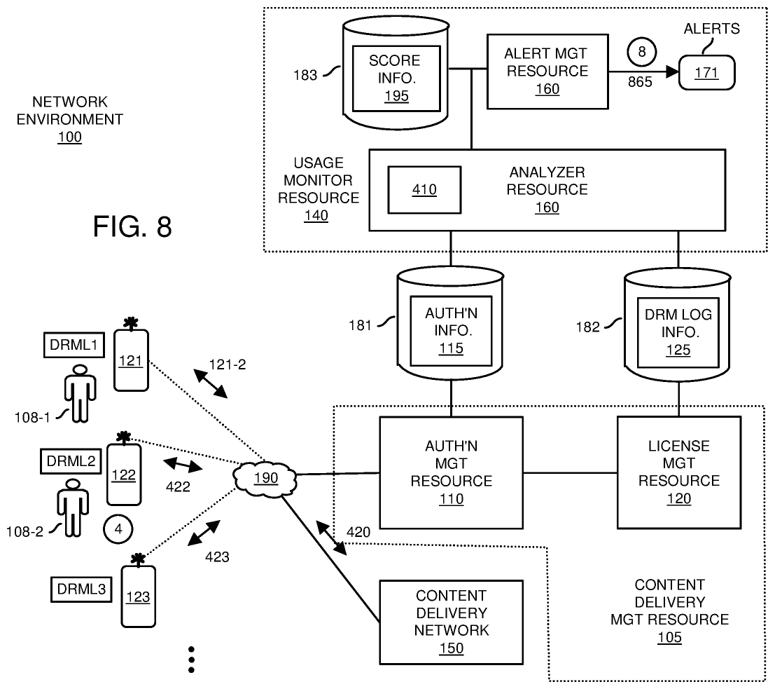

This high value for CSCORE=19 indicates misuse of the credentials associated with the subscriber account SA1 to retrieve content. If desired, the alert management resource 160 can be configured to compare the magnitude of the CSCORE=19 to threshold level of 15. In response to detecting that the CSCORE is greater than 15 for one or more days, the alert manager resource 160 can be configured to generate an alert indicating possible improper usage or high usage associated with the subscriber account SA1 (see FIG. 8).

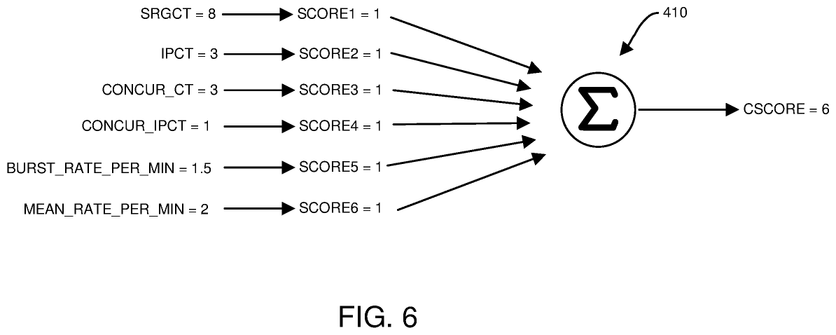

As another example, as shown in FIG. 6 via implementation of function 410, assume that the alert management resource 160 detects that, for another given day associated with subscriber account SA1:
SRGCT=8 falls in range 1 to 10 so score1=1;
IPCT=3 (three communication devices with different network address) falls in range 2 to 3 so score2=1;
CONCUR_CT=2 falls in range 2 to 3 so score3=1;
CONCUR_IPCT=1 falls in range 1 so score4=1;
BURST_RATE_PER_MIN=1.5 falls in range 1 to 2 so score5=1;
MEAN_RATE_PER_MIN=2 falls in range 2 to 3 so score6=1

Via the function 410, the usage monitor resource 140 generates a respective value for CSCORE based on one or more of the metrics:

$$CSCORE = SRGCT + IPCT + CONCUR\_CT + CONCUR\_IPCT + Burst\_RATE \_PER \_MIN + MEAN\_RATE \_PER \_MIN = 1 + 1 + 1 + 1 + 1 + 1 = 6$$

This low value for CSCORE=6 indicates lack of misuse of the credentials associated with the subscriber account SA1 to retrieve content. If desired, the alert management resource 160 can be configured to compare the magnitude of the CSCORE=6 to threshold level of 15. In response to detecting that the CSCORE is substantially lower than 15 for one or more days, the alert manager resource 160 can be configured to prevent generation of an alert indicating possible improper usage or high usage associated with the subscriber account SA1.

Note that as an alternative to determining a respective range in which each metric falls, embodiments herein can include, via the analyzer resource or other suitable entity, apply a first weight value to the first numerical value (such as associated with the metric SRGCT) to produce a first weighted value; apply a second weight value to the second numerical value (such as associated with the metric IPCT to produce a second weighted value; and so on for each value. The analyzer resource can be configured to generate the usage metric (such as usage metric CSCORE) for the subscriber account SA1 based on summing one or more of the first weighted value, the second weighted value, and so on.

As previously discussed, the sum of one or more of the above metrics (such as generated value CSCORE) can be used as an overall measure of misuse with maximum total score of 30 and minimum score being 6.

TABLE 2

| Total | |
|---|---|
| Composite Score | |
| (CSCORE) | Rating |
| 1 to 6 | Low |
| 7 to 12 | Moderate |
| 13 to 18 | High |
| 19 to 24 | Very High |
| 25 to 30 | Extreme |

An account with composite overall score (CSCORE) between 1 to 6 would indicate the level of system abuse is low, while an account with composite score between 25 to 30 would indicate the level of system abuse is extreme. Using these metrics in table 1 such as SRGCT, IPCT, CONCUR_CT, CONCUR_IPCT. BURST_RATE_PER_MIN, MEAN_RATE_PER_MIN to create composite scores for all accounts can help prioritize accounts (such as including subscriber account SA1) that should be investigated first due to high level of abuse and the ability to automate the process using AI/ML (Artificial Intelligence/Machine Learning). The settings of the individual metrics (such as SRGCT, IPCT, CONCUR_CT, CONCUR_IPCT, BURST_RATE_PER_MIN, MEAN_RATE_PER_MIN) provide information as to the number of independent users or bots (such as communication device 123 and the like) involved in theft events (improper use of authentication credentials associated with the subscriber account SA1 to obtain tokens and retrieve requested content). Specifically, in one example embodiment, the burst_rate_per_min and the mean_rate_per_min provide more direct insight as to the involvement of bot automation when the settings of one or more of each of these parameters is greater than a respective threshold level.

Accordingly, embodiments herein include, via the usage monitor resource 140, deriving one or more usage metrics (score information 195) for the subscriber account SA1 based on authentication tracking logs 115 associated with authenticating the communication devices 121, 122, 123, etc., generating the multiple requests.

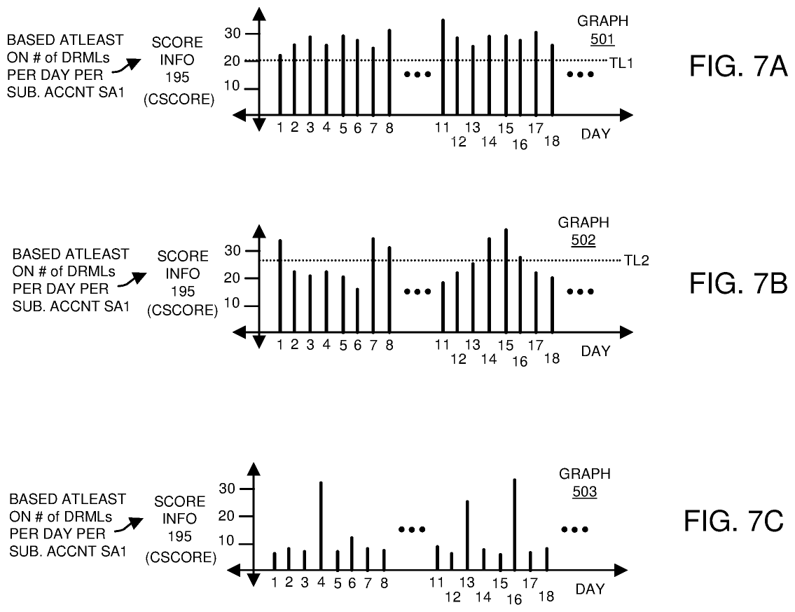

FIGS. 7A, 7B, and 7C are example diagrams tracking generation of multiple instances of playback management information (such as digital rights management licenses) for a respective subscriber account as discussed herein.

When computed metrics and the corresponding generated composite score (for the computed metrics as indicated by score information 195) are applied for a respective subscriber account SA1 and each other account over a period of time, respective patterns emerge indicating abusive accounts and the potential cause. The method as discussed herein can be configured to provide proper alerts (see FIG. 8) of over usage (use of the subscriber account SA1 above a threshold level) without infringing on customer privacy because the corresponding customer location, corresponding content consuming habit, and preferences are never revealed.

One of the multiple known issues is “bad” actors (unauthorized entities) using bots and automation and obtained token T1 (or other suitable information associated with the subscriber account SA1) to make improper DRM license requests to the authentication management resource 110 and/or corresponding content delivery management resource 105 (platform). Graph 501 shows an example composite score generated each day for subscriber account SA1 that is consistently above 20 (threshold level of 20 each day) for over a two-month time duration, indicating unusually high usage and that the respective subscriber account SA1 may be shared widely by multiple different communication devices (authorized and potentially unauthorized).

In addition, the consistent high usage score on a daily basis in graph 501 does not show humanistic TV (video) watching behavior where an average user watches more video content over the weekend than during the weekdays. The graph 501 therefore implies the abuse associated with retrieving and playback of content associated with the subscriber account SA1 is likely from bots and automation systems (such as communication device 123 and other communication devices) that consistently make requests irrespective of time of day or day in a week to retrieve and playback different content.

Another known issue is account abused potentially by account owner or compromised account that might be part of credential stuffing scheme by unauthorized entities without the owner's knowledge (such as head-of-household user 108-1 paying subscriber fees for use of subscriber account SA1). Graph 502 shows composite scores that vary from 10 to 25 during a time duration (day 1=Sunday, day 2=Monday, day 3=Tuesday, day 4=Wednesday, day 5=Thursday, day 6=Friday, day 7=Saturday, day 8=Sunday, day 9=Monday, . . . , day 14=Saturday, day 15=Sunday, and so on) in which usage scores associated with the subscriber account SA1 are higher toward the weekend than during the weekdays. This pattern also indicates abuse with humanistic behavior where a respective account might also be widely shared intentionally and/or unintentionally with other users on weekends above a reasonable threshold level TL2 such as distribution of 25 digital rights management license and requests for content per weekend day.

Another scenario that this composite score method can identify is when account starts to trend away from normal use over time as shown in graph 503. Example 3 shows composite score ranges between with occasional spikes. By day 4, composite score surpassed 10 with spike past 20 on day 13 and day 16. This pattern indicates that the account in the example might be compromised recently that led to higher composite score than it previously had.

FIG. 8 is an example diagram illustrating generation of an alert indicating detected misuse or irregularities associated with a subscriber account and corresponding retrieval of content as discussed herein.

In In operation #8, the alert management resource 160 monitors a magnitude of the scores generated for each of multiple different subscriber accounts provided by a respective service provider to distribute requested content and corresponding use licenses. The alert management resource 160 generates communications 865 including alerts 171 for any subscriber account that appear to experience abuse.

In one example, the alert management resource 160 detects that the usage associated with the subscriber account SA1 is above a respective reasonable threshold level. In response to such a condition, the alert management resource 160 can be configured to provide notification to the content delivery management resource 105 to discontinue providing content delivery service to communication devices associated with the subscriber account SA1.

Accordingly. in accordance with further examples, a magnitude of the usage metric (such as indicated by score information 195) for the subscriber account SA1 indicates a degree of video asset demand associated with the subscriber account SA1. The alert management resource 170 can be configured to compare the magnitude of the usage metric to a threshold level and produce a notification indicating misuse of the digital rights management licenses in response to detecting that the magnitude of the usage metric is greater than the threshold level.

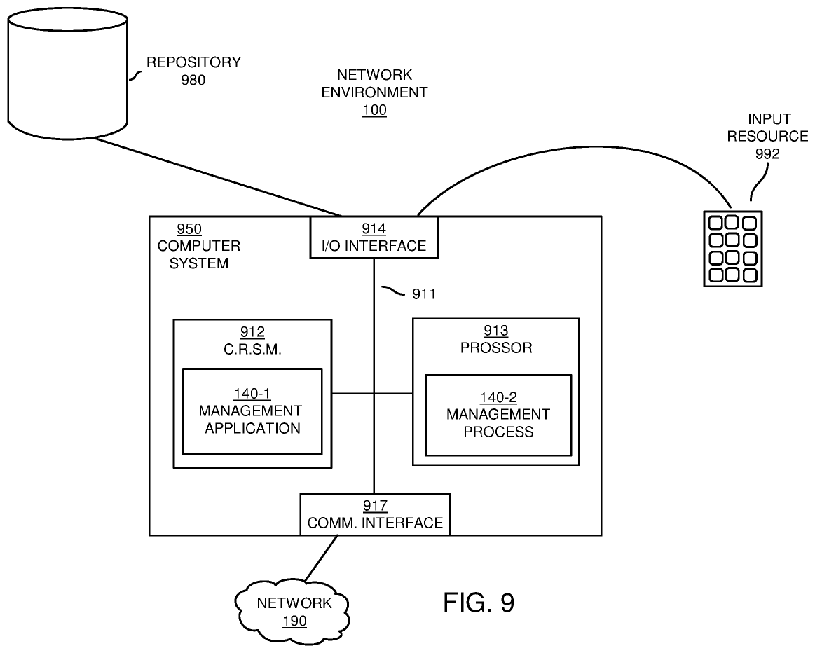

FIG. 9 is an example block diagram of a computer system for implementing any of the operations as previously discussed according to embodiments herein.

Note that any of the resources (such as information content delivery management resource 105, authentication management resource 110, license management resource 120. usage monitor resource 140, function 410, analyzer resource 160, alert management resource 170, etc.) as discussed herein can be configured to include computer processor hardware and/or corresponding executable instructions to carry out the different operations as discussed herein.

For example, as shown, computer system 950 of the present example includes interconnect 911 coupling computer readable storage media 912 (such as a non-transitory type of media, computer readable storage hardware, etc., in which digital information such as instructions can be stored and or retrieved), a processor 913 (computer processor hardware), I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one embodiment, the computer readable storage medium 912 is computer-readable storage hardware that stores instructions and/or data.

As shown, computer readable storage media 912 can be encoded with management application 140-1 (e.g., including instructions) in a respective wireless station to carry out any of the operations as discussed herein.

During operation of one embodiment, processor 913 accesses computer readable storage media 912 (computer-readable storage hardware) via the use of interconnect 911 in order to launch, run, execute, interpret or otherwise perform the instructions in management application 140-1 stored on computer readable storage medium 912. Execution of the notification application 140-1 (a.k.a., management application) produces management process 140-2 (a.k.a., management process) to carry out any of the operations and/or processes as discussed herein.

Those skilled in the art will understand that the computer system 950 can include other processes and/or software and hardware components, such as an operating system that controls allocation and use of hardware resources to execute the notification application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer. mainframe computer system, handheld computer, workstation, network computer, application server, storage device. a consumer electronics device such as a camera, camcorder, set top box. mobile device, video game console, handheld video game device, a peripheral device such as a switch, modem, router, set-top box, content management device, handheld remote control device. any type of computing or electronic device, etc. The computer system 950 may reside at any location or can be included in any suitable resource in any network environment to implement functionality as discussed herein.

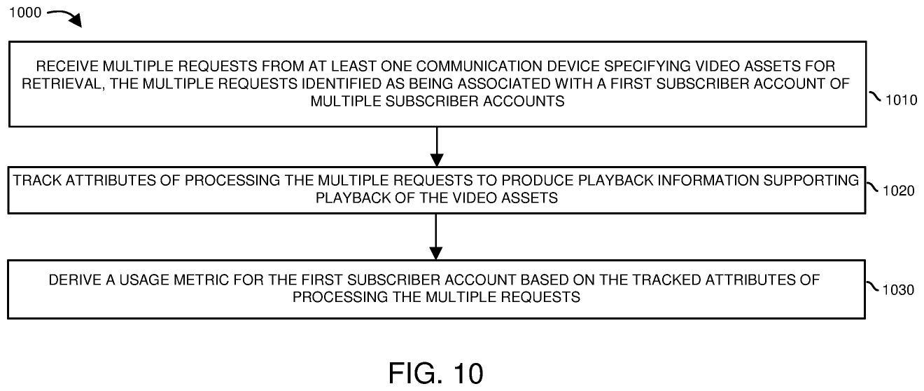

Functionality supported by the different resources will now be discussed via flowcharts in FIG. 10. Note that the steps in the flowcharts below can be executed in any suitable order.

FIG. 10 is a flowchart 1000 illustrating an example method according to embodiments herein. Note that there will be some overlap with respect to concepts as discussed above.

In processing operation 1010, the device management resource 105 receives multiple requests (R1-1, R1-2, . . . , R2-1, R2-2, . . . , R3-1, R3-2 . . . ) from communication devices 121, 122, 123, etc., specifying video assets (content) for retrieval. The content delivery management resource 105 identifies the multiple requests as being associated with a first subscriber account SA1 of multiple subscriber accounts via credentials provided by the communication devices indicating that they are associated with the respective subscriber account SA1.

In processing operation 1020, via storage of authentication log information 115 and digital rights management log information 125. the content delivery management resource 105 tracks attributes of processing the multiple requests (such as number of requests per communication device, number of simultaneous requests from multiple communication devices within a time duration, etc.) to produce playback information (such as digital rights management license information) supporting decryption and playback of the video assets by the communication devices.

In processing operation 1030, the usage monitor resource 140 derives one or more subscriber account usage metrics for the first subscriber account SA1 based on the tracked attributes of processing the multiple requests as captured by the authentication log information 115 and/or the digital rights management log information 125.

Note again that techniques herein are well suited to identify misuse of subscriber account information such as tokens to retrieve video or other content for playback. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context. operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
receiving multiple requests specifying video assets for retrieval, each of the multiple requests identified as being associated with a first subscriber account of multiple subscriber accounts;
tracking attributes of processing the multiple requests to produce playback information supporting playback of the video assets; and
deriving a usage metric for the first subscriber account based on the tracked attributes of processing the multiple requests.

2. The method as in claim 1 further comprising:
in response to receiving the multiple requests: i) generating the playback information, and ii) distributing the playback information to communication devices generating the multiple requests.

3. The method as in claim 2 further comprising:
prior to distributing the playback information to the communication devices:
generating decryption information to decrypt the video assets; and
producing the playback information to specify the generated decryption information to decrypt the video assets specified by the multiple requests.

4. The method as in claim 1, wherein a magnitude of the usage metric for the first subscriber account indicates a degree of video asset demand associated with the first subscriber account;
wherein the playback information includes digital rights management licenses, the method further comprising:
comparing the magnitude of the usage metric to a threshold level; and
producing a notification indicating misuse of the digital rights management licenses in response to detecting that the magnitude of the usage metric is greater than the threshold level.

5. The method as in claim 1 further comprising:
tracking attributes of processing the multiple requests associated with the first subscriber account without regard to identities of the video assets being requested for playback.

6. The method as in claim 1 further comprising:
tracking the attributes of processing the multiple requests associated with the first subscriber account without regard to identities of users of the communication devices generating the multiple requests.

7. The method as in claim 1, wherein the tracked attributes include a first attribute and a second attribute;
wherein the first attribute is based on a number of the multiple requests received within a predetermined time duration; and
wherein the second attribute is based on unique identities of communication devices generating the multiple requests.

8. The method as in claim 7, wherein deriving the usage metric includes:
producing a first numerical value from the first tracked attribute; and
producing a second numerical value from the second tracked attribute.

9. The method as in claim 8, wherein deriving the usage metric includes:
applying a first weight value to the first numerical value to produce a first weighted value;
applying a second weight value to the second numerical value to produce a second weighted value; and
generating the usage metric for the first subscriber account based on the first weighted value and the second weighted value.

10. The method as in claim 1 further comprising:
deriving the usage metric for the first subscriber account based on authentication tracking logs associated with authenticating communication devices generating the multiple requests.

11. The method as in claim 1 further comprising:
deriving the usage metric for the first subscriber account based on management logs associated with producing the playback information in response to the multiple requests.

12. The method as in claim 1 further comprising:
wirelessly communicating the playback information over wireless communication links to multiple communication devices generating the multiple requests.

13. A system comprising:
communication management hardware operative to:
receive multiple requests specifying video assets for retrieval, the multiple requests identified as being associated with a first subscriber account of multiple subscriber accounts;
track attributes of processing the multiple requests to produce playback information supporting playback of the video assets; and
derive a usage metric for the first subscriber account based on the tracked attributes of processing the multiple requests.

14. The system as in claim 13, wherein the communication management hardware is further operative to:
in response to receiving the multiple requests: i) generate the playback information, and ii) distribute the playback information to multiple communication devices.

15. The system as in claim 14, wherein the communication management hardware, prior to distribution of the playback information to the communication devices, is further operative to:
generate decryption information to decrypt the video assets; and
produce the playback information to specify the generated decryption information to decrypt the video assets specified by the multiple requests.

16. The system as in claim 13, wherein a magnitude of the usage metric for the first subscriber account indicates a degree of video asset demand associated with the first subscriber account; and
wherein the communication management hardware is further operative to:
compare the magnitude of the usage metric to a threshold level; and
produce a notification indicating misuse of the digital rights management licenses in response to detecting that the magnitude of the usage metric is greater than the threshold level.

17. The system as in claim 13, wherein the communication management hardware is further operative to:
track attributes of processing the multiple requests associated with the first subscriber account without regard to identities of the video assets being requested for playback.

18. The system as in claim 13, wherein the communication management hardware is further operative to:
track the attributes of processing the multiple requests associated with the first subscriber account without regard to identities of users of communication devices generating the multiple requests.

19. The system as in claim 13. wherein the tracked attributes include a first attribute and a second attribute;
wherein the first attribute is based on a number of the multiple requests received within a predetermined time duration; and
wherein the second attribute is based on unique identities of communication devices generating the multiple requests.

20. The system as in claim 19, wherein the communication management hardware is further operative to:
produce a first numerical value from the first tracked attribute; and
produce a second numerical value from the second tracked attribute.

21. The system as in claim 20, wherein the communication management hardware is further operative to:
apply a first weight value to the first numerical value to produce a first weighted value;
apply a second weight value to the second numerical value to produce a second weighted value; and
generate the usage metric for the first subscriber account based on the first weighted value and the second weighted value.

22. The system as in claim 13, wherein the communication management hardware is further operative to:
derive the usage metric for the first subscriber account based on authentication tracking logs associated with authentication of communication devices generating the multiple requests.

23. The system as in claim 13, wherein the communication management hardware is further operative to:
derive the usage metric for the first subscriber account based on management logs associated with producing the playback information in response to the multiple requests.

24. The system as in claim 13, wherein the communication management hardware is further operative to:
wirelessly communicate the playback information over wireless communication links to communication devices generating the multiple requests.

25. Computer-readable storage hardware having instructions stored thereon, the instructions, when carried out by computer processor hardware, cause the computer processor hardware to:
receive multiple requests specifying video assets for retrieval, the multiple requests identified as being associated with a first subscriber account of multiple subscriber accounts;
track attributes of processing the multiple requests to produce playback information supporting playback of the video assets; and
derive a usage metric for the first subscriber account based on the tracked attributes of processing the multiple requests.
